(19) United States
(12) Patent Application Publication
(10) Pub. No.: US 2014/0052552 A1
(43) Pub. Date: Feb. 20, 2014

(54) COMPUTER BIOS CONTROL OF CASH DRAWER

(71) Applicants: Binh T. TRUONG, Houston, TX (US); Larry W. Kunkel, Spring, TX (US); Nam Nguyen, Houston, TX (US)

(72) Inventors: Binh T. TRUONG, Houston, TX (US); Larry W. Kunkel, Spring, TX (US); Nam Nguyen, Houston, TX (US)

(21) Appl. No.: 13/587,188

(22) Filed: Aug. 16, 2012

(51) Int. Cl. G06Q 20/08

(52) U.S. Cl. 705/18

(57) ABSTRACT

Access to a cash drawer is controlled by way of a basic input-output system (BIOS) of an associated computer. The BIOS can provide for local user access to the cash drawer by way of password, designated keystroke, or other procedure. A local or remote user can reconfigure cash drawer access procedures, establish time clock-based scheduling, or affect other control parameters by way of graphical user interface (GUI) stored in the BIOS. Cash drawer security, management options and user convenience are improved accordingly.

### BACKGROUND

Cash handling and related point-of-sale apparatus are now commonly computer controlled. A cash drawer is coupled to a computer and user access is regulated by corresponding functions of the computer. The present teachings address the foregoing and related concerns.

### BRIEF DESCRIPTION OF THE DRAWINGS

The present embodiments will now be described, by way of example, with reference to the accompanying drawings, in which:

FIG. 1 depicts a block diagram of a computer-based cash drawer system according to one example of the present teachings;

FIG. 2 depicts aspects of a basic input-output system (BIOS) according to another example;

FIG. 3 depicts a flow diagram of a computer-based method according to one example;

FIG. 4 depicts a flow diagram of a computer-based method according to another example;

FIG. 5 depicts a flow diagram of a computer-based method according to yet another example;

FIG. 6 depicts a flow diagram of a computer-based method according to another example.

### DETAILED DESCRIPTION

### Introduction

Access to a cash drawer is controlled by way of a basic input-output system (BIOS) of an associated computer. The BIOS can provide for local user access to the cash drawer by way of a password or passwords, designated keystrokes, usage of electronic keys, or other procedures or devices. A local or remote user can reconfigure the cash drawer access procedures, establish time-based access scheduling, or affect other control parameters by way of a graphical user interface (GUI) stored in the BIOS. Cash drawer security, management options and user conveniences are improved accordingly.

In one example, a computer-readable storage media includes a program code that defines a basic input-output system (BIOS) for a computer. The BIOS is programmed to cause the computer to control access to a cash drawer.

In another example, a system includes a computer and a cash drawer coupled to the computer. The system also includes a solid-state storage media supported within the computer, the media including a computer code defining a basic input-output system (BIOS). The BIOS is configured to cause the computer to control user access to the cash drawer.

### Illustrative System

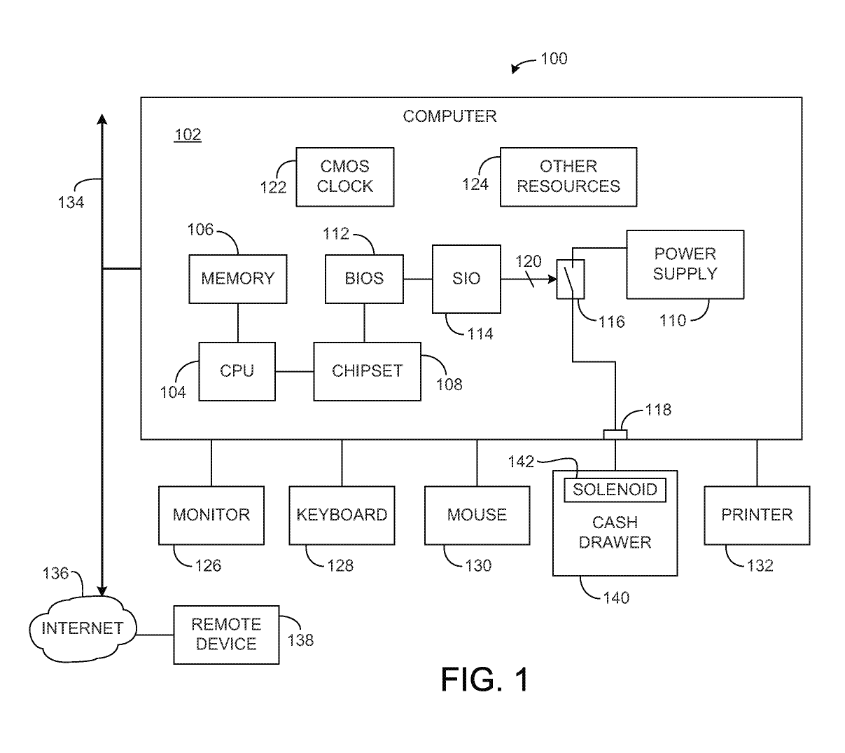

Attention is now turned to FIG. 1, which depicts a system 100 according to the present teachings. The system 100 is illustrative and non-limiting with respect to the present teachings. Other systems, devices, assemblies and arrangements can also be defined and used.

The system 100 includes a computer 102. The computer 102 includes a central processing unit (processor, or CPU) 104. The processor 104 is configured to perform various operations in accordance with a machine-readable program code. The computer 102 also includes a memory 106. The memory 106 can be defined by any machine-accessible solid-state storage configured to store and retrieve data, program code, and the like. The memory 106 is coupled in signal communication with the processor 104.

The computer 102 also includes a chipset 108. The chipset 108 can be variously defined and can include any suitable electronics, application specific integrated circuits (ASICs), communications-related devices and the like configured to cooperate with (i.e., communicate and/or be controlled by) the processor 104. The computer 102 also includes a power supply 110 configured to provide conditioned, regulated electrical power at one or more voltages. The power supply 110 is configured to provide electrical energy to the processor 104 and other elements of the computer 102.

The computer 102 also includes a machine-readable program code defining a basic input-output system (BIOS) 112, which is embodied within a computer-accessible storage media. In one example, the BIOS 112 is stored within an electrically erasable programmable read-only memory (EEPROM). In other example, the BIOS 112 is stored within FLASH memory. Other suitable storage media can also be used to store the BIOS 112.

The BIOS 112 includes program code configured to cause the processor 104 (i.e., the computer 102) to start-up and initiate operations, commonly referred to as “booting up”. The BIOS 112 further includes program code defining various utilities and functions for controlling operation of a cash drawer, which the processor 104 is alerted to (i.e., flagged, or made aware of) during the start-up process. Such functions and utilities will be described in further detail hereinafter.

The computer 102 includes serial input-output (SIO) 114 circuitry configured to couple the BIOS 112 in controlling relationship with a switching element 116. The computer 102 also includes the switching element 116 introduced immediately above. The switching element 116 can be defined by a transistor, relay, or other suitable element configured to selectively couple or isolate an electrical voltage with an output node 118 in accordance with signaling 120 received from the SIO 114.

The computer 102 also includes a solid-state or CMOS clock (clock) 122. The clock 122 is defined by a dedicated-purpose circuit configured to keep time-of-day and date information after being set in accordance with user input. The clock 122 can be initially set (or thereafter reset) to a desired date and time in accordance with an access-controlled protocol. That is, the clock 122 can be set or reset only under user password input, electronic key usage, or another secured process that is resistant or invulnerable to unauthorized access. Other suitable clocks or access protocols can also be used.

The computer 102 further includes other resources 124. Such other resources can include, without limitation, wireless communications circuitry, network communications resources, solid-state data storage, magnetic or optical data storage, video or audio signal processing circuitry, and so on. Other resources can also be included or used. One having ordinary skill in the computer or related arts will appreciate other such other resources includable within a computer, and further elaboration is not germane to the present teachings.

The system 100 also includes a monitor (or display) 126, a keyboard 128, a mouse 130 and a printer 132, each coupled to the computer 102. Each of the respective peripherals 126-132 can be variously defined and is configured to cooperate with the computer 102 as is familiar to one having ordinary skill in the art. The system 100 also includes a network 134 coupled in data or signal communication with the computer 102. The network 134 can be defined by a local-area network (LAN), a wide-area network (WAN) or other suitable network of peripherals or computers. The network 134 is coupled to the Internet 136, such that a remote device 138 can communicate with the computer 102.

The system 100 also includes a cash drawer 140 coupled to the computer 102. The cash drawer 140 is configured to support paper currency, coins, negotiable paper or other things of value within a box or safe-like structure. The cash drawer 140 includes a solenoid 142 that defines, or is a portion of, an electrically actuated locking mechanism of the cash drawer 140. The cash drawer 140 is opened by voltage signaling sent to the solenoid 142 from the computer 102 by way of the output node 118.

In one example, the solenoid 142 is configured to open the cash drawer 140 in response to a twenty-four volt pulse received from the computer 102. Other configurations can also be used. In at least one example, the cash drawer 140 does not include a manually actuated key-type locking mechanism and is controlled (opened) exclusively by electrical signaling.

Normal, typical operations of the system 100 are generally as follows: The processor 104 starts up operations in accordance with machine-readable program code within the BIOS 112. The BIOS 112 also flags the processor 104 to the presence of program code directed to cash drawer control during the start up process. Thereafter, the processor is referred to other program code stored within the memory 106, within disk storage of the other resources 124, and so on.

The BIOS 112 further includes program code configured to establish access protocol for the cash drawer 140. In just one example, the BIOS 112 can include program code directed to time-of-day access, such that a user can only access the cash drawer 140 between 8:00 AM and 6:00 PM local time on weekdays (Monday-Friday). The processor 104 operates according to such time-of-day access program code, thus establishing the hours of access for the cash drawer 140.

The solenoid 142 operates to keep the cash drawer 140 secured in a closed and locked condition. A user can access the cash drawer 140 by way of a predetermined keyboard 128 entry, by clicking the mouse 130 on an “OPEN” soft-switch displayed on the monitor 126, and so on. In one example, a user can open the cash drawer 140, during allowed access hours, by way of an “F10” keystroke on the keyboard 128. Other access procedures can also be used. The computer 102 can also be used in accordance with other applications (e.g., an operating system, an accounting or inventory tracking program, and so on) while simultaneously controlling access to the cash drawer 140.

### Illustrative Bios

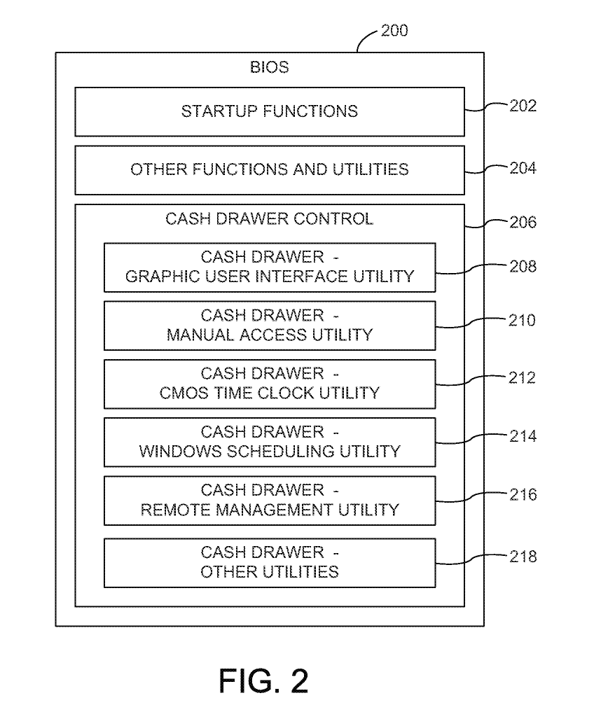

Reference is now made to FIG. 2, which depicts machine-readable (executable) program code defining a basic input-output system (BIOS) 200 in accordance with the present teachings. The BIOS 200 is illustrative and non-limiting, and the present teachings contemplate other BIOS having other respectively varying features and characteristics, The BIOS 200 is embodied by way of a solid-state storage media, a FLASH-memory integrated circuit, or other suitable machine-accessible storage electronics,

The BIOS 200 include startup code 202. The startup code 202 is configured to cause a processor (e.g., 104) to perform various initial operations upon power-up or another restart scenario. Thus, the startup code 202 loads appropriate values into respective registers, directs the processor to address other program code stored elsewhere in the corresponding computer (e.g., 102), and so on. One having ordinary skill in the computer arts is familiar with startup or “boot-up” code and procedures.

The startup code 202 also sets a flag or flags such that the processor is alerted to and can access cash drawer-related program code 206 as described hereinafter. The BIOS 200 also includes other code 204 that can be configured to cause the processor to perform various other functions or utilities that are not germane to the present teachings.

The BIOS 200 also includes cash drawer control program code (drawer code) 206. The drawer code 206 is configured to cause the processor to perform respective access-control functions over to a cash drawer (e.g., 140). Illustrative examples of such access-control functions are described below.

The drawer code 206 includes a graphic user interface (GUI) utility 208. The GUI utility 208 is configured to present a graphical control panel or display to a user by way of a computer monitor. The graphical control panel can display respective soft-switches, user-configurable time-of-day access tables, user-configurable day-of-week or holiday access tables, user-settable access passwords, and so on. The GUI utility 208 is therefore generally configured to provide a familiar, graphically-based context in which a user can establish or change access to the associated cash drawer.

The drawer code 206 also includes a manual access utility 210. The manual access utility 210 is configured to cause the associated cash drawer to open in response to a predetermined (or reconfigurable) user input to the computer. In one example, the cash drawer is caused to open in response to a user pressing “F10” on the computer keyboard. In another example, the cash drawer opens in response to a user clicking an “OPEN” button or icon on a display screen. In yet another example, the cash drawer opens in response to a user entering a predetermined (or reconfigurable) password via the computer keyboard. The manual access utility 210 can be configured for other suitable manual access procedures, as well.

The drawer code 206 also includes a CMOS time clock utility (clock utility) 212. The clock utility 212 is configured to perform time-of-day and/or day-of-week accessibility to the cash drawer as governed by a solid-state (i.e., CMOS) clock (e.g., 122) of the computer. The clock utility 212 can also be configured such that a user can set (or reset) the solid-state dock by way of password access, an electronic key, or other security protocol.

For example, a user establishes a time-of-day access schedule for the cash drawer by way of the GUI utility 208, which is then made effective once the reconfiguration is complete. The dock utility 212 then causes the processor to allow (or deny) access to the cash drawer in accordance with that access schedule and as governed by time kept by the solid-state dock. To illustrate, if the time-of-day schedule forbids cash drawer access after 6:00 PM, and the solid-state dock has the present time at 9:14 PM, then the cash drawer remains locked and inaccessible.

The drawer code 206 also includes windows scheduling utility (windows utility) 214. The windows utility 214 is configured to display various cash drawer access control features to a user by way of a Microsoft Windows (registered trademark) operating system of the computer. The windows utility can provide for various GUI features analogous to those described above in regard to the GUI utility 208. Other functions or features can also be provided.

The drawer code 206 also includes a remote management utility (remote utility) 216. The remote utility 216 is configured such that a user can monitor or reconfigure access to the cash drawer by way of remote device (e.g., 138). The remote utility 216 thus provides for access to the computer associated with the cash drawer by way of Internet-based communication. The remote utility 216 can include password or encryption key-based security protocol, a GUI interface encoded for Internet-based communication to a remote user, and so on. A remote user can reconfigure time-of-day access scheduling, reset passwords, enable or disable access by respective local users (e.g., employees), and so on, by way of the remote utility 216.

The drawer code 206 further includes other utilities 218. The other utilities 218 can provide additional management or security-related functions directed to controlled access to the cash drawer. Such other utilities can include, without limitation, identifying authorized cash drawer users, defining their respective passwords, hand-shake protocols for associating or validating electronic keys, and so on.

### First Illustrative Method

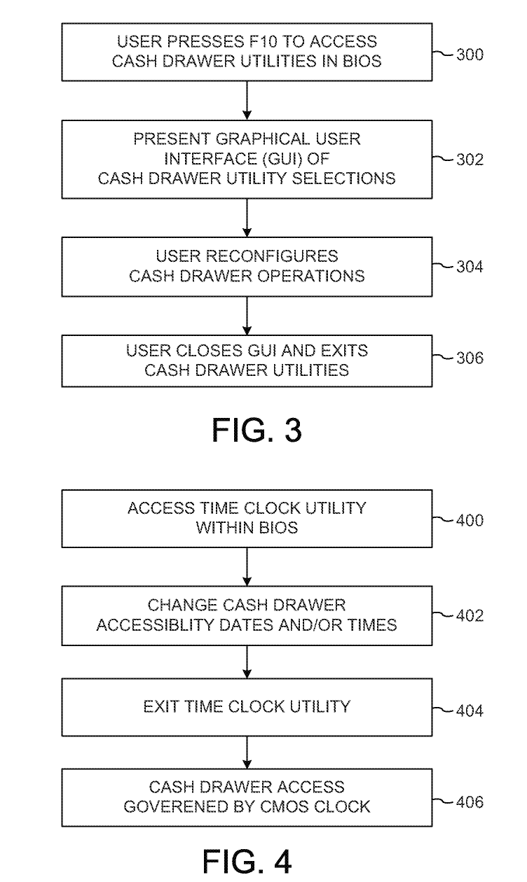

Attention is directed now to FIG. 3, which depicts a flow diagram of a method according to the present teachings. The method of FIG. 3 includes particular steps performed in a specific order of execution. However, other methods including other steps, omitting one or more of the depicted steps, or proceeding in other orders of execution, can also be used. Thus, the method of FIG. 3 is illustrative and non-limiting with respect to the present teachings. Reference is also made to FIG. 1 in the interest of illustrating the method of FIG. 3.

At 300, a user presses “F10” on a keyboard to access cash drawer utilities within a BIOS. For purpose of a present example, user of the computer 102 presses the “F10” key on the keyboard 128, causing the processor 104 to access cash drawer-related utilities (i.e., program code) within the BIOS 112.

At 302, a graphical user interface depicting cash drawer utility selections is presented to a user. For purposes of the present example, program code within the BIOS 112 causes the computer 102 to display a GUI of cash drawer control selections on the monitor 126. Such control selections can include time-of-day scheduling tables, password reconfiguration options, and so on.

At 304, a user reconfigures cash drawer operations. For purposes of the present example, a user re-establishes day-of-week scheduling by adding Saturday accessibility to the cash drawer 140. Other reconfiguration options are also possible.

At 306, the user closes the GUI and exits from the cash drawer utilities. For purposes of the present example, a user input causes the BIOS 112 to close the GUI. The reconfiguration performed at step 304 above is then made effective, and remains so, until future changes are made, if any.

### Second Illustrative Method

Reference is made now to FIG. 4, which depicts a flow diagram of a method according to the present teachings. The method of FIG. 4 includes particular steps performed in a specific order of execution. However, other methods including other steps, omitting one or more of the depicted steps, or proceeding in other orders of execution, can also be used. Thus, the method of FIG. 4 is illustrative and non-limiting with respect to the present teachings. Reference is also made to FIG. 1 in the interest of illustrating the method of FIG. 4.

At 400, a time clock utility is accessed within BIOS. For purposes of a present example, a user accesses a time clock utility within the BIOS 112. Thereafter, the user is presented with a graphical display on the computer monitor 126 including control selections and parameters subject to user change or reconfiguration.

At 402, a user changes cash drawer accessibility dates and/or times. For purposes of the present example, the user changes values within a time-of-day scheduling table for access to the cash drawer 140. For instance, the user changes the time-of-day setting to allow access to the cash drawer 140 from 8:30 AM to 9:00 PM every weekday.

At 404, a user exits the time clock utility. For purposes of the present example, the user exits the time dock utility, dosing the graphical display and making the new time-of-day scheduling effective.

At 406, access to the cash drawer is governed by a CMOS dock of the computer. For purposes of the present example, user access to the cash drawer 140 is allowed in accordance with the schedule as set at step 402 above, and in accordance with the solid-state dock 122. That is, access to the cash drawer 140 is allowed whenever the time, as kept by the dock 122, is within the hours of 8:30 AM and 9:00 PM on each of the five weekdays. The cash drawer 140 is otherwise secured in a closed and locked condition, except as possibly provided by other functions of the BIOS 112 (e.g., management password or electronic key override, and so on).

### Third Illustrative Method

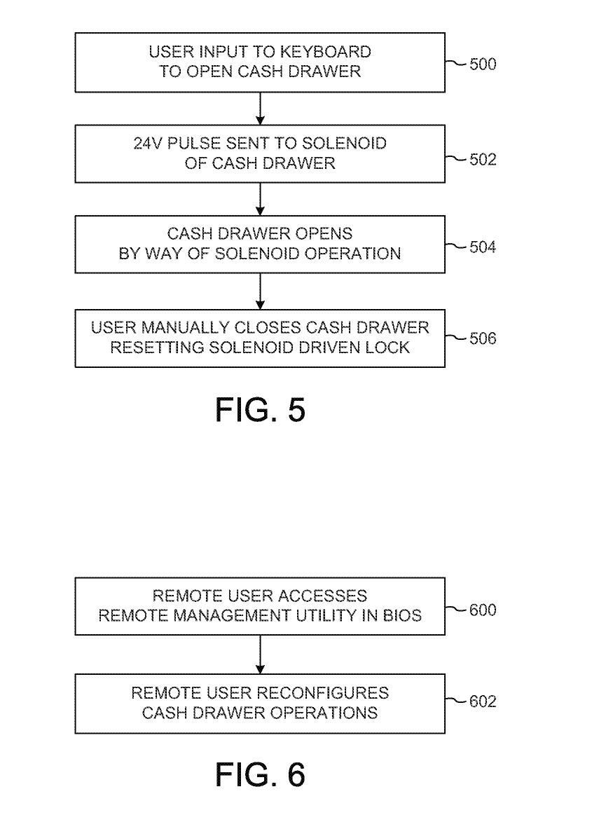

Attention is now turned to FIG. 5, which depicts a flow diagram of a method according to the present teachings. The method of FIG. 5 includes particular steps performed in a specific order of execution. However, other methods including other steps, omitting one or more of the depicted steps, or proceeding in other orders of execution, can also be used. Thus, the method of

FIG. 5 is illustrative and non-limiting with respect to the present teachings. Reference is also made to FIG. 1 in the interest of illustrating the method of FIG. 5.

At 500, a user input is made to open a cash drawer. For purposes of a present example, a user presses an “F10” key on the keyboard 128 of the computer 102. In accordance with program code of the BIOS 112, electronics embodying the BIOS 112 issue a signal to the serial input/output (SIO) 114, coded as a command to open the cash drawer 140.

At 502, at twenty-four volt pulse is sent to a solenoid of the cash drawer. For purposes of the present example, the SIO 114 causes a momentary closure of the switching element 116, resulting in the issuance of a 24-volt pulse of electrical energy to the solenoid 142 by way of the output node 118.

At 504, the cash drawer opens by way of solenoid operation. For purposes of the present example, the solenoid 142 momentarily disengages the locking mechanism (i.e., a latch) causing the cash drawer 140 to open. The cash drawer 140 can include a loaded spring or similar mechanism to push or urge the actual cash receiving tray or structure into or toward an open condition. The user can now place things into, or remove things from, the cash drawer 140.

At 506, a user manually closes the cash drawer, resetting the solenoid driven lock. For purposes of the present example, a user pushes the cash drawer 140 into a closed position, causing the solenoid 142 to re-latch the cash receiving tray in a shut and secured state. The cash drawer 140 is now inaccessible until the next authorized access procedure is performed.

### Fourth Illustrative Method

Reference is made now to FIG. 6, which depicts a flow diagram of a method according to the present teachings. The method of FIG. 6 includes particular steps performed in a specific order of execution. However, other methods including other steps, omitting one or more of the depicted steps, or proceeding in other orders of execution, can also be used. Thus, the method of FIG. 6 is illustrative and non-limiting with respect to the present teachings. Reference is also made to FIG. 1 in the interest of illustrating the method of FIG. 6.

At 600, a remote user accesses the remote management utility in the BIOS. For purposes of a present example, user of the remote device 138 establishes communication with the computer 102 by way of the Internet 136. The remote user then provides a password, employs an encryption key, or makes use of some other security token in order to gain access to the remote management utility of the BIOS 112. In response, the BIOS 112 causes the computer 102 to transmit a GUI with management control selections to the remote device 138.

At 602, the remote user reconfigures cash drawer operations. For purposes of the present example, the user at the remote device 138 makes selections that are communicated to the computer 102 so as to reconfigure access to the cash drawer 140. For instance, the remote user can remove local user (e.g., an employee) from an authorization list, deleting their access password or disabling their electronic key in the process. In another illustration, the remote user can set new time-of-day or day-of-week scheduling for access to the cash drawer 140. Other operations can also be performed. Once the remote user is done, they close the remote management utility GUI causing the reconfiguration changes to take effect.

In general, and without limitation, the present teachings contemplate any number of devices, systems and methods directed to computer-based cash drawer access control. A BIOS includes program code to cause a computer to perform various secured access procedures with respect to a cash drawer. Such procedures can include local user access by way of keystroke, time-of-day scheduling, password or electronic key management, usage of encryption codes, governance of cash drawer access according to a solid-state clock, and so on. Remote management of cash drawer access procedures and security settings can also be performed in accordance with program code of the BIOS. Other cash drawer-based utilities and features can also be implemented by way of the BIOS.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

1. A non-transitory computer-readable storage media, comprising:
a program code defining a basic input-output system (BIOS) for a computer, the BIOS to cause the computer to control access to a cash drawer;
the BIOS to control the cash drawer in accordance with a user-defined accessibility schedule.

2. The non-transitory computer-readable storage media according to claim 1, the
computer-readable storage media defined by a solid-state storage device.

3. The non-transitory computer-readable storage media according to claim 1, the BIOS to present a graphic user interface (GUI) corresponding to control of the cash drawer.

4. (canceled)

5. The non-transitory computer-readable storage media according to claim 1, the BIOS such that the user-defined accessibility schedule is governed in accordance with a solid-state clock of the computer.

6. The non-transitory computer-readable storage media according to claim 1, the BIOS to control the cash drawer in accordance with input received from a user located remote to the computer.

7. The non-transitory computer-readable storage media according to claim 1, the BIOS to cause the cash drawer to open in response to a user input to the computer.

8. A system, comprising:
a computer;
a cash drawer coupled to the computer; and
a solid-state storage media supported within the computer and including a computer code defining a basic input-output system (BIOS), the BIOS to cause the computer to control user access to the cash drawer,
the BIOS to cause the computer to control user access to the cash drawer in accordance with a user-defined schedule.

9. The system according to claim 8, the BIOS to cause the computer to present a graphic user interface (GUI) corresponding to user access to the cash drawer.

10. The system according to claim 8, the schedule being governed by a solid-state clock of the computer.

11. The system according to claim 8, the BIOS to cause the computer to control user access to the cash drawer in accordance with input received from a user remotely located with respect to the computer.

12. The system according to claim 8, the BIOS to allow user access to the cash drawer in accordance with a user input to the computer.

13. The system according to claim 12 further comprising a keyboard coupled to the computer, the BIOS such that the user input includes pressing a predetermined key of the keyboard.

14. The system according to claim 8, the computer to issue an electrical pulse to the cash drawer, the cash drawer to open in response to the electrical pulse.

15. The system according to claim 8, the cash drawer including a solenoid-based locking mechanism to operate in response to electrical signaling from the computer, the cash drawer not including a key-based manually-actuated locking mechanism.
